(19) United States
(12) Patent Application Publication
(10) Pub. No.: US 2008/0127338 A1
(43) Pub. Date: May 29, 2008

(54) SYSTEM AND METHOD FOR PREVENTING MALICIOUS CODE SPREAD USING WEB TECHNOLOGY

(75) Inventors: Bumrae CHO, Seongnam-si (KR); Kwanhee HONG, Uiwang-si (KR); Myeongseok CHA, Seoul (KR); Wontae SIM, Seongnam-si (KR); Woohan KIM, Seoul (KR)

Correspondence Address: CANTOR COLBURN, LLP, 20 Church Street, 22nd Floor, Hartford, CT, 06103, US

(73) Assignee: KOREA INFORMATION SECURITY AGENCY, Seoul (KR)

(21) Appl. No.: 11/552,765

(22) Filed: Oct. 25, 2006

(30) Foreign Application Priority Data
Sep. 26, 2006 (KR) 10-2006-0093262

(51) Int. Cl. G06F 11/00

(52) U.S. Cl. 726/22

(57) ABSTRACT

The present invention relates to a system and a method for preventing an attack of a malicious program spread using a web technology comprising a malicious code distribution site detection server comprising a malicious code distribution site detector for detecting a malicious code distribution site, and a prevention message transmitter for transmitting a prevention message to a routing configuration server, wherein the prevention message includes an IP address of the malicious code distribution site detected by the malicious code distribution site detector; a plurality of routers including a virtual IP address; and the routing configuration server for advertising the IP address of the malicious code distribution site such that a routing path of a packet having the IP address of the malicious code distribution site as a target address or an starting address is guided to the virtual IP address according to an reception of the prevention message to block a connection to the malicious code distribution site.

### BACKGROUND OF THE INVENTION

The present invention relates to a system and a method for preventing an attack of a malicious program spread using a web technology wherein an IP address is detected by automatically searching for a malicious code distribution site and applying the IP address to a plurality of routers to block a distribution of a malicious code.

An infection path of a malicious software or a malicious code through a communication network become diverse by taking advantage of the fast growing waves of the Internet, and a damage is increasing every year. The malicious code is a software programmed to carry out a malicious act such as intentionally destroying a system or leaking a private information against an interest of a user. The malicious code includes a virus, a worm, a trojan, a backdoor, a logic bomb, a hacking tool such as a trap door, and a malicious spyware and ad-ware. While the malicious code has self-duplicating or automatic reproduction function, the malicious code causes problems such as leakage of the private information such as a user ID and a password, a takeover of a subject system, a file deletion/system destruction, a service denial of an application/system, a leakage of important data, and installation of other hacking programs.

As the internet progresses, the number of websites are drastically increasing, and maintaining a security of every website at a certain level has become almost impossible. Therefore, a new hacking scheme wherein the website having a low security level is hacked to hide the malicious code and to infect a system of the user visiting the web site or a site linked to the web site with the malicious code is increasing. Particularly, since the malicious code, according to types thereof, is designed to destroy the user's computer or the system on a network or leak a confidential information, the user's computer system or the security thereof may be fatally damaged.

However, most of newly created malicious codes cannot be scanned or disinfected by a conventional vaccine. Therefore, when the user is not cautious, the malicious code quickly spreads itself through the network while an administrator of a corresponding web server or a visitor of the site does not recognize the infection of the malicious code.

However, up to now, it is general that the administrator of the corresponding web server or the user on whom a damage has been inflicted reports to a hacking victim site or a vaccine distribution site to take post measures. That is, a discovery of and a response to the malicious code has been user-oriented such that an operation for detecting a malicious code distribution site and preventing a distribution of the malicious code cannot be promptly carried out.

Therefore, in most of cases, when the user recognizes the damage, the malicious code is already spread out while it is impossible to find and punish a first distributor of the malicious code or to disinfect and restore the computer system and the server infected with the malicious code. Accordingly, a need for a system which detects the infection of the malicious code and automatically blocks the malicious code at an early stage in order to prevent the spreading of the damage due to the infection of the malicious code.

### SUMMARY OF THE INVENTION

It is an object of the present invention to provide a system and a method for preventing an attack of a malicious code spread using a web technology wherein a malicious code distribution site or a relay site is automatically detected using a HTML web page source and a referrer information of a plurality of websites and a user connection to the malicious code distribution site or a spreading of the malicious code using a remote triggered blackhole routing.

In addition, it is another object of the present invention to provide a system and a method for preventing an attack of a malicious code spread using a web technology wherein a change in a routing configuration is exchanged a remote triggered blackhole routing technology without replacing an security equipment and changing the system is exchanged, that is a routing information between a blackhole router and a edge router is exchanged using a interior/border gateway protocol remotely to minimize a degradation of an equipment performance and without a large amount of a replacement cost.

Finally, it is yet another object of the present invention to provide a system and a method for preventing an attack of a malicious code spread using a web technology wherein the malicious code distribution site is automatically detected and the routing information is automatically applied to the router in order to collect and block the malicious code hidden in the plurality of websites to be distributed and relayed, thereby promptly blocking a use connection to the malicious code distribution site and informing the malicious code distribution site to collect and analyze the malicious code.

In order to achieve the above-described object, there is provided a system for preventing a malicious code spread using a web technology, the system comprising: a malicious code distribution site detection server comprising a malicious code distribution site detector for detecting a malicious code distribution site, and a prevention message transmitter for transmitting a prevention message to a routing configuration server, wherein the prevention message includes an IP address of the malicious code distribution site detected by the malicious code distribution site detector; a plurality of routers including a virtual IP address; and the routing configuration server for advertising the IP address of the malicious code distribution site such that a routing path of a packet having the IP address of the malicious code distribution site as a target address or an starting address is guided to the virtual IP address according to an reception of the prevention message to block a connection to the malicious code distribution site.

In addition, the malicious code distribution site detector comprises a domain database having a domain of a website to be monitored registered therein, and wherein the malicious code distribution site detector monitors the website periodically or non-periodically to check whether a link information to the malicious code distribution site is included in the domain database so as to detect a malicious code relay site.

There is also provided a method for preventing a malicious code spread using a web technology, the method comprising: (a) detecting a malicious code distribution site; (b) applying a prevention message including an IP address of the detected malicious code distribution site to a plurality of routers; and (c) forwarding, by the plurality of routers, an IO packet from and to the malicious code distribution site to a predetermined virtual IP space.

In addition, the step (a) comprises: (a-1) connecting to a website to be monitored by receiving a domain list of the website from a domain database or arbitrarily connecting to the website; (a-2) collecting a source code including at least one of HTML source code, a XML source code and a script source code of the website and comparing the collected source code and a malicious code pattern stored in a malicious code pattern database to check whether the malicious code is hidden; and (a-3) analyzing a referrer information of the website to check whether a link to the malicious code distribution site is included in the referrer information to simultaneously connect to a referrer site and detect the malicious code distribution site by a method identical to the step (a-2).

In addition, the step (b) comprises: (b-1) generating the prevention message including the IP address of the malicious code distribution site and a router control code; and (b-2) transmitting the prevention message to a separate routing configuration server to configure a routing path of an IP address to be blocked for each of the plurality of routers, or directly transmitting the prevention message to the plurality of routers to configure the routing path of the IP address to be blocked.

In addition, the step (c) comprises: (c-1) designating one of the plurality of routers as a routing configuration server; (c-2) assigning a null0 of the virtual IP space to the plurality of routers; (c-3) advertising to the plurality of routers using an internal/external gateway protocol such that the plurality of routers directs the IO packet from and to the malicious code distribution site to the null0; and (c-4) dropping, by the plurality of routers, the 10 packet having the IP address of the malicious code distribution site as a starting address or a target address to the null0.

### BRIEF DESCRIPTION OF THE DRAWINGS

FIG. 1 is a diagram illustrating a damage to a user terminal caused by a malicious code distribution site and a malicious code relay site.

FIG. 2 is a schematic diagram illustrating a system for preventing a malicious code spread using a web technology in accordance with an embodiment of the present invention.

FIG. 3 is a block diagram illustrating a configuration of a malicious code distribution site detection server in accordance with an embodiment of the present invention.

FIG. 4 is a diagram exemplifying a configuration of a malicious code prevention message in accordance with an embodiment of the present invention.

FIGS. 5 through 7 are diagrams illustrating types of inserted malicious codes in a web page.

FIGS. 8 through 10 are diagrams illustrating an analysis result of CPU resource occupancy rate test of various security functions according to a generation of an attack traffic.

FIG. 11 is a diagram illustrating a concept of a remote triggered blackhole routing process.

FIG. 12 is a diagram illustrating routers wherein a remote triggered blackhole routing technology is applied thereto in accordance with an embodiment of the present invention.

FIG. 13 is a flow diagram illustrating a method for preventing a malicious code spread using a web technology in accordance with an embodiment of the present invention.

FIG. 14 is a flow diagram illustrating a process for applying a remote triggered blackhole routing technology to router in accordance with an embodiment of the present invention.

FIG. 15 is a flow diagram illustrating an operating relation between elements of a system for preventing a malicious code spread using a web technology in accordance with an embodiment of the present invention.

[Description of reference numerals]

| | | | |
|---|---|---|---|
| 10 | user | 20 | distribution site |
| 30 | relay site | 50 | attacking tool |
| 200 | malicious code distribution site | | |
| | detection server | | |
| 220 | malicious code pattern database | | |
| 240 | prevention message transmitter | | |
| 250 | malicious code distribution site detector | | |
| 260 | domain database | | |
| 280 | post-monitoring unit | | |
| 300 | routing configuration server | | |
| 350 | blackhole routing server | | |
| 550 | edge router | 400 | website |
| 500 | router | | |

### DETAILED DESCRIPTION OF THE INVENTION

The above-described objects and other objects and characteristics and advantages of the present invention will now be described in detail with reference to the accompanied drawings.

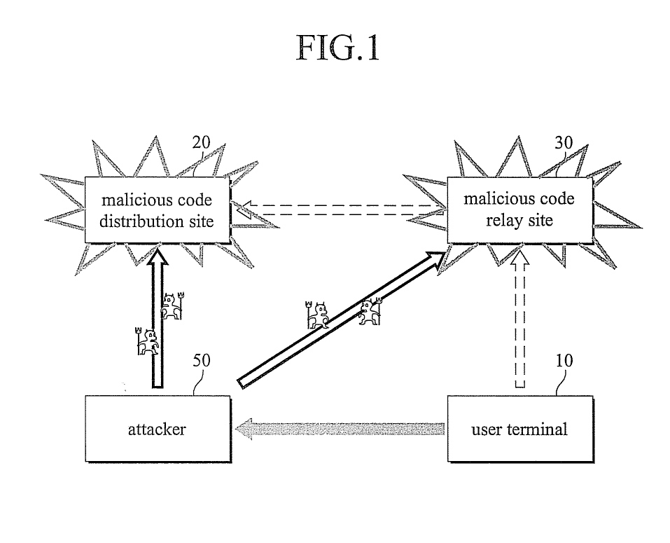

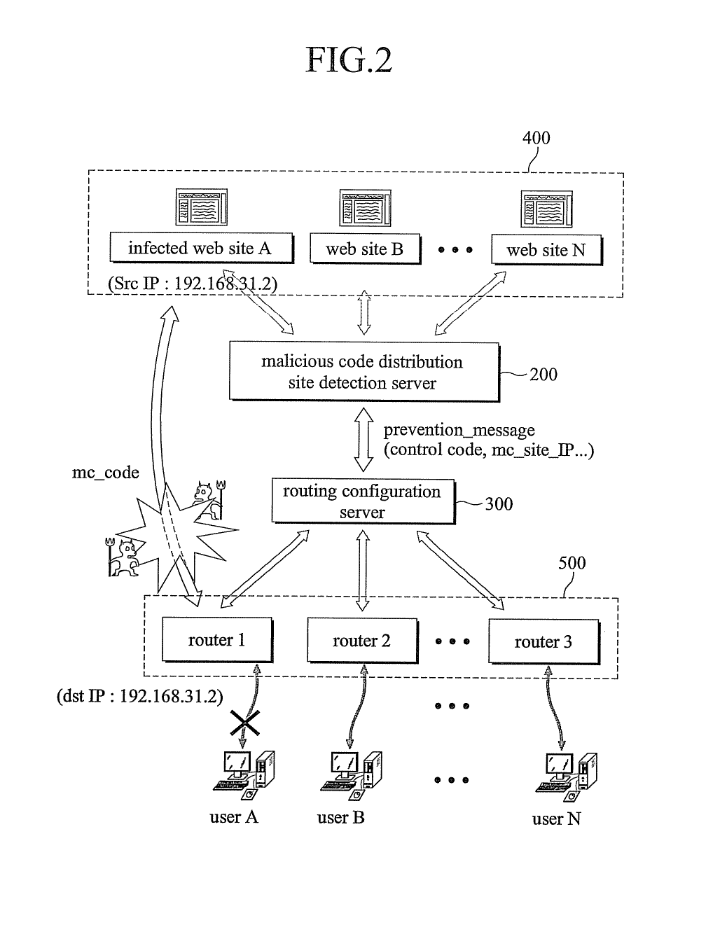

FIG. 1 is a diagram illustrating a damage to a user terminal caused by a malicious code distribution site and a malicious code relay site, and FIG. 2 is a schematic diagram illustrating a system for preventing a malicious code spread using a web technology in accordance with an embodiment of the present invention.

On the other hand, like reference numerals in the accompanied drawings refer to like elements.

Referring to FIGS. 1 and 2, an attacker 50 hides a malicious code by hacking a certain website having a large number of accesses of users or by building a website of his/her own, and uses the certain website having the large number of accesses of the users as a relay site 30 to upload the malicious code to a user computer 10 from a distribution site 20 where the malicious code is hidden to infect the same when the user connects to the relay site 30.

When the user (or the user computer 10) connects to the distribution site 20 directly or via the relay site 30, the malicious code in the malicious code distribution site 20 is executed to infect the user computer 10, and a private information such as a user ID and a password are exposed to the attacker 50. In order to prevent a spreading of the malicious code, a system for preventing a malicious code spread using a web technology in accordance with an embodiment of the present invention comprise a malicious code distribution site detection server 200 and a routing configuration server 300.

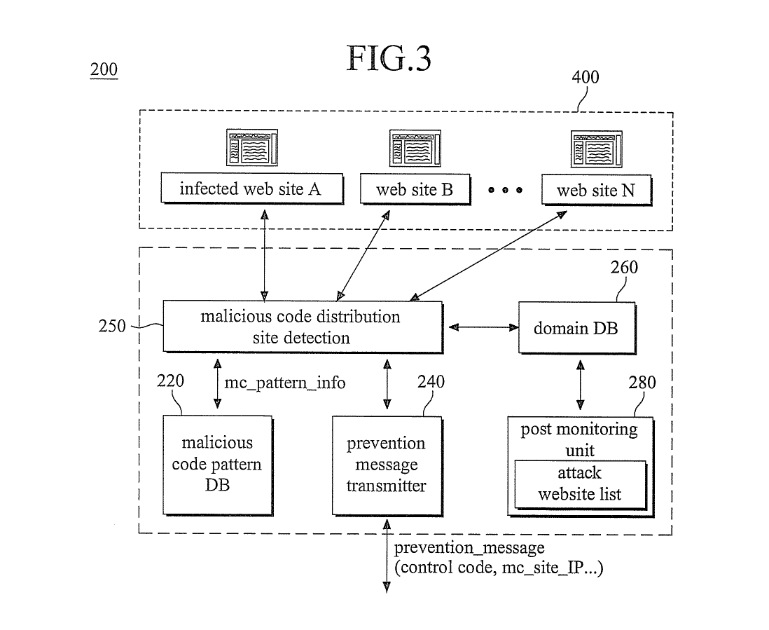

The malicious code distribution site detection server 200 includes a web robot for automatically detecting a plurality of websites to check whether the malicious code is hidden in the website. In order to achieve this, a malicious code distribution site detector 250 collects a source such as an HTML, an XML (Extensible Markup Language) and a script from a main page of the website and a link page and also compares the source such as the HTML and the XML to a malicious code pattern in a malicious code pattern database (see FIG. 3) to determined that the malicious code is hidden when the source contains the malicious code pattern. In addition, the malicious code distribution site detector 250 analyzes a referrer of the searched website to check whether the referrer arbitrarily modified or a link information of other sites is modified to be linked to the malicious code distribution site 20 so as to determine the malicious code distribution site 20 or the relay site 30. Moreover, the malicious code distribution site detection server 200 informs the hacking to a system operator of the sites 20 and 30 and transmits a prevention message P_msg including an IP (Internet Protocol) address of the malicious code distribution site 20 and a router control code to the routing configuration server 300.

The routing configuration server 300 receives the prevention message P_msg from the malicious code distribution site detection server 200 to register the IP address of the malicious code distribution site 20 in routers 500 in a AS (Autonomous System) such that a user connection to the malicious code distribution site 20 is blocked while blocking a traffic including the malicious code coming in from the malicious code distribution site 20 simultaneously. In order to achieve this, the routing configuration server 300 employs a remote triggered blackhole routing technology. The remote triggered blackhole routing technology integrates a null0 routing technology and an IBGP (Interior Border Gateway Protocol), wherein a packet heading for a certain target site or a packet transmitted from a certain starting site is forwarded to a virtual IP address (null0) of the router to drop the malicious code while forwarding a certain packet having the IP address of the malicious code distribution site as a starting IP address or a target IP address to the null0 to be dropped for other routers (edge routers) using the IBGP simultaneously.

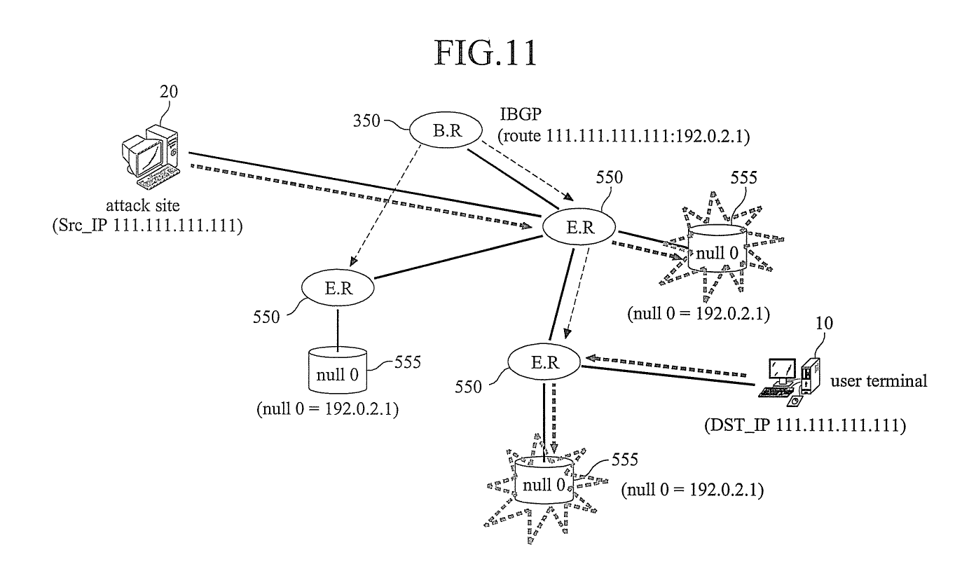

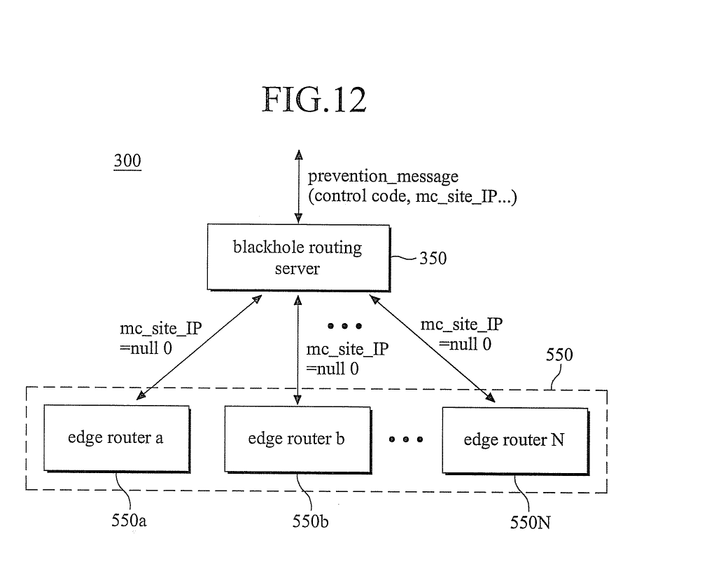

In order to employ the remote triggered blackhole routing technology, the routing configuration server 300 is an IBGP server for advertising to the edge routers in order to route the packet to a remote triggered blackhole, that is to direct an attack packet including a certain IP address to a predetermined IP address (null0) or an IP block, wherein an arbitrary router is designated as a separate blackhole routing server and configures the edge routers to secure the null0 region in advance. A detailed description with respect to this matter will be described with reference to FIGS. 11 and 12 later.

A detailed constitution of the malicious code distribution site detection server 200 and the routing configuration server 300 and a relation therebetween will now be described.

FIG. 3 is a block diagram illustrating a configuration of the malicious code distribution site detection server 00 in accordance with an embodiment of the present invention.

Referring to FIG. 3, the malicious code distribution site detection server 200 in accordance with the embodiment of the present invention comprises the malicious code distribution site detector 250, a prevention message transmitter 240, a domain database 260, a malicious code pattern database 220 and a post-monitoring unit 280.

The malicious code distribution site detector 250 obtains a domain information from the domain database 260 wherein a list containing a site to be monitored and an order of priority for the site to be monitored is stored to automatically monitor a plurality of websites 400. The malicious code distribution site detector 250 checks whether the malicious code is hidden in the plurality of websites 400 to detect the malicious code distribution site. That is, the malicious code distribution site detector 250 collects the source such as a HTML web page source the main page of the website and the link page to be compared to the malicious code pattern mc_pattern_info in the malicious code pattern database 220, thereby detecting whether the malicious code is inserted in the website. In order to achieve this, the malicious code distribution site detector 250 refers to a critical domain list or randomly collects the HTML web page source from the main page of the website, wherein the collected source is parsed and analyzed to extract a link information, thereby collecting the link information and a related HTML source. On the other hand, when the malicious code distribution site detector 250 detects the malicious code distribution site 20, the malicious code distribution site detector 250 analyzes the referrer or a cookie of the plurality of websites 400 to check whether the referrer is arbitrarily modified, the link information of other sites is fabricated and an automatic link to 0- is set, thereby detecting whether one of the plurality of websites 400 is used as the relay site 30. Thereafter, in order to block a network packet including the IP address of the malicious code distribution site 20 at a router level, the prevention message transmitter 240 generates and transmits the prevention message P_msg including, for example, the IP address mc_site_ip of the malicious code distribution site 20 and the router control code to the routing configuration server 300.

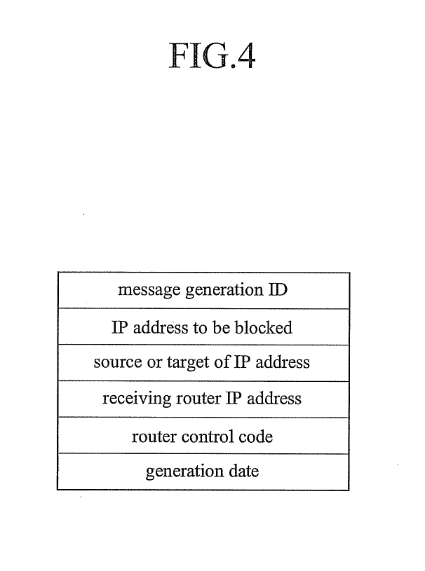

As shown in FIG. 4, the prevention message P_msg including a message generation ID containing an identification information such as an address of the routing configuration server (MAC address, IP address), the IP address to be blocked which is the address of the malicious code distribution site 20, an information on a starting address or a target address of the IP address, a receiving router IP address which is an address of a receiving router, a router control code information for configuring an operation mode (drop, release) of the router to be controlled, and a date of the message generation.

On the other hand, various malicious code pattern informations mc_pattern_info according to various type of inserting the malicious code in the plurality of websites 400 are stored in the malicious code pattern database 220. Representative methods for hiding the malicious code by hacking the certain website are as follows.

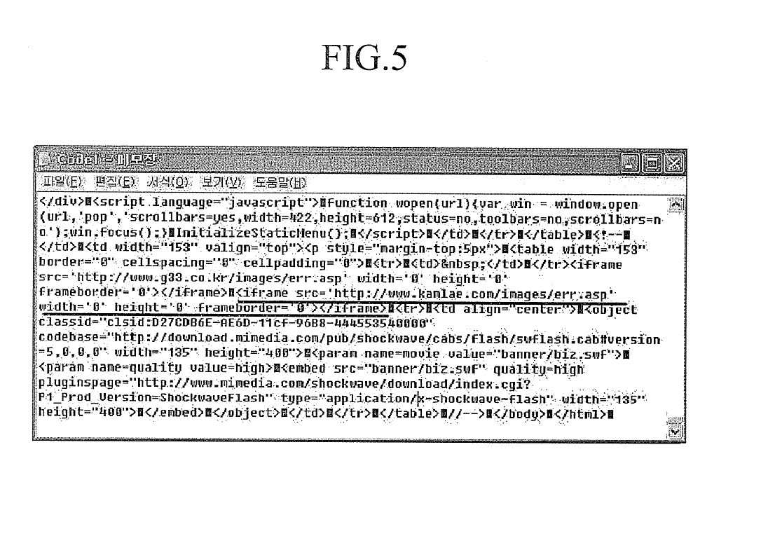

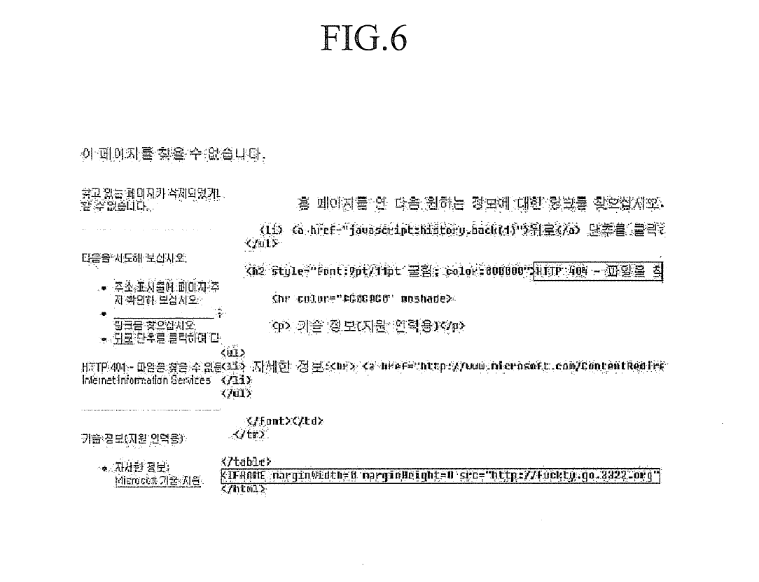

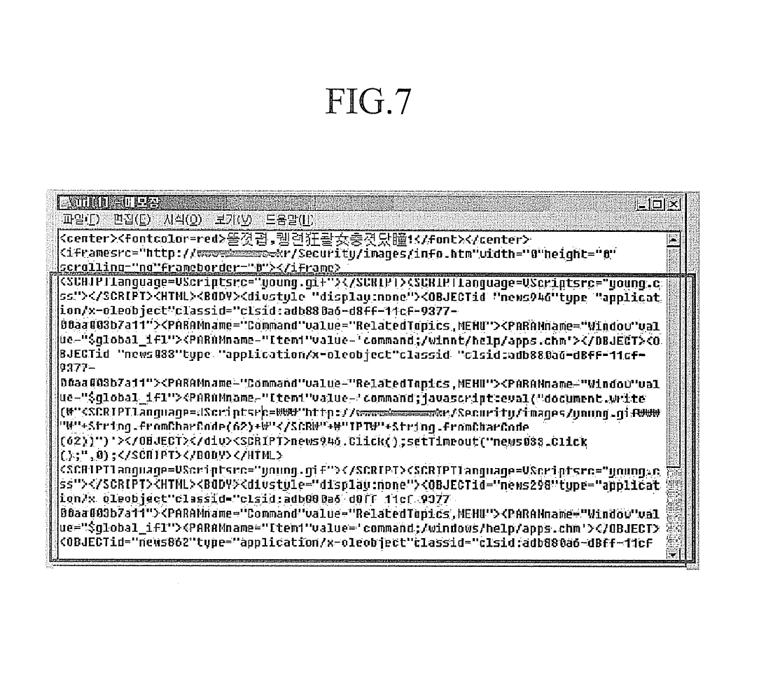

A method shown in FIG. 5 wherein IFRAME tag command which is a tag for linking to other sites is inserted in the HTML source of the certain website to redirect to the malicious code distribution site 20 or the relay site 30, a method shown in FIG. 6 wherein a page that does not exist in the relay site 30 is linked to redirect to the malicious code distribution site 20 using a HTTP 404 error page, and a method shown in FIG. 7 wherein the script containing the malicious code inserted in a HTML document are some of the representative methods. In addition, hiding the various malicious codes by inserting a code such as an object tag code, a script tag code in the HTML document is also possible and a corresponding malicious code pattern information may be stored in the malicious code pattern database.

When the malicious code distribution site 20 is blocked via the router, the malicious code distribution site detection server 200 informs the system operators of the malicious code distribution site 20 and the relay site 30 of the hacking of the website and the blocking of a user connection so that a post management may be carried out. The malicious code distribution site detection server 200 adds the website as an attack website through the post-monitoring unit 280. The malicious code distribution site detector 250 re-detects whether the malicious code is hidden in the malicious code distribution site 20 by referring to the attack website list after a predetermined period. When the malicious code is deleted, the blocking is released so that a service may restart.

A method for effectively blocking the network packets having the IP address mc_site_ip of the malicious code distribution site 20 as a target IP address and a starting IP address transmitted from the malicious code distribution site detection server 200 will now be described.

Representative network security technology based on IP includes an ACL, the null0 routing, an uRPF and a rate-limit, and a technology for tracing the attack includes a netflow technology that is capable of analyzing a traffic flow.

Specifically, the ACL (Access Control List) technology is a most universal technology for blocking a malicious traffic, wherein the blocking based on the IP address, a service port and the content is possible. However, the method may act as a cause for a performance degradation due to a large load on a network equipment when a separate ASIC (Application Specific Integrated Circuit) module for an access control. For organizations having a large number of network equipments such as an ISP, a script for updating an access control policy to the equipments should be separately generated, or logon to the equipments separately for configuration.

The rate limit technology refers to a technology wherein when an amount of a flow of a certain service or a packet having a certain pattern is more than a predetermined amount in a unit time, the packet exceeding the amount is not passed. The technology is also refereed to as a rate filtering, and may be useful when limiting a bandwidth of an attack packet of a fake IP address such as a SYN flooding or a Smurf attack. However, a normal packet may be blocked as well as an abnormal packet, and an overload of the router may occur when there isn't a dedicated unit carrying out a corresponding function.

The uRPF (unicast Reverse Path Forwarding) technology is for blocking an attack spoofing the starting IP address, wherein the router checks whether a reverse path to a corresponding IP address exists by checking the starting IP address to trust the starting IP address. Since most of Distributed Denial of Services spoofs the starting IP address, uRPF may be a very effective as a blocking means to a denial of service attack. However, the uRPF technology has a limitation of application when a non-symmetric network structure wherein a plurality of routing paths (a strict mode cannot be used), and cannot deal with various denial of service attacks except the spoofing.

The null0 routing is a technology for forwarding and dropping a packet heading for a certain target to a virtual interface referred to as null0. The null0 routing is also referred to as a blackhole routing or a blackhole filtering, that employs a forwarding function which is a basic function of the network equipment such that the overload of the equipment rarely occurs while providing only an IP based (L3) filtering.

In accordance with the netflow technology, the source and the target addresses, a number of bytes of a flow, a number of packets, a traffic inflow interface and an upstream peer information may be monitored through an analysis of a traffic flow. The netflow technology allows checking through which interface a malicious spoofing traffic is flowing in. however, a trace of an attacker using the netflow technology requires an access privilege to an entire network equipments on an attack path, and the analysis should be completed while the attack is in progress.

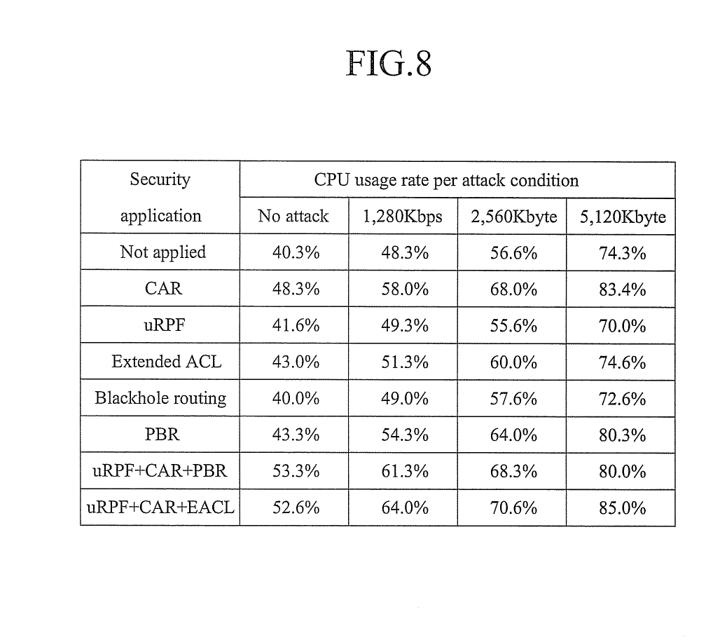

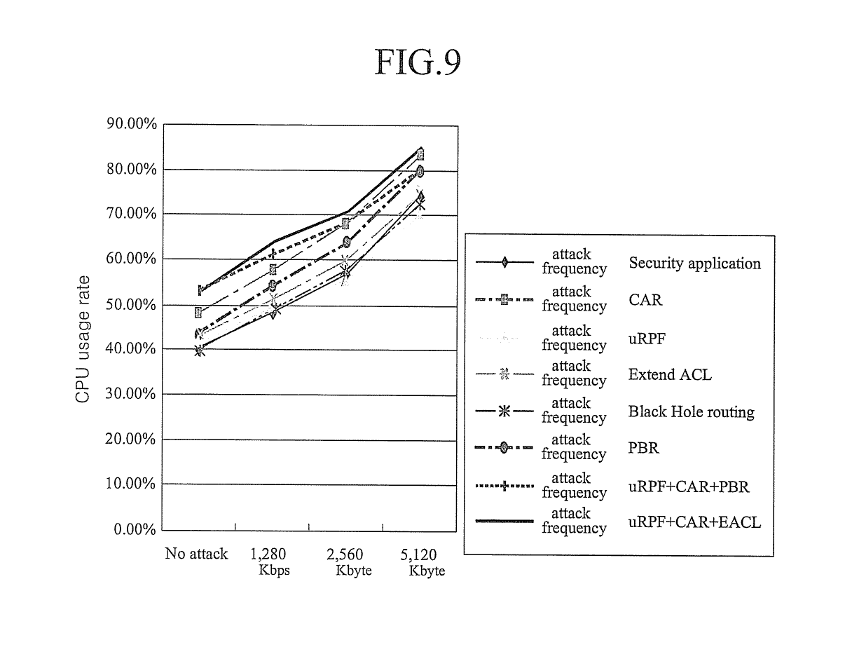

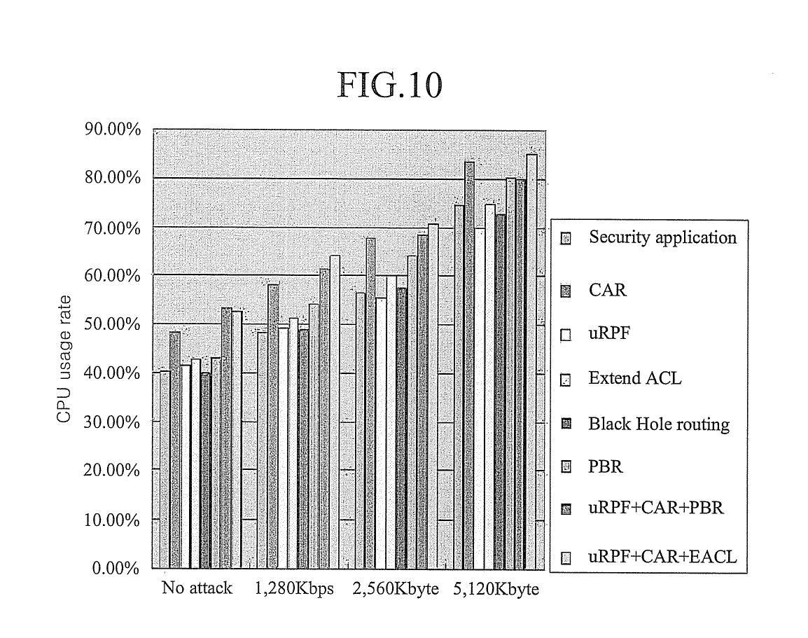

An experiment for comparing effects on an equipment performance when the above-described method for blocking the malicious code is shown in FIGS. 8 through 10.

A CPU load is measured according to an experiment environment including a CAR (Commit Access Rate) wherein an abnormally amplified traffic is controlled by allocating a bandwidth for a certain protocol except the null0 routing (or the blackhole routing) and the uRPF, a polt and the IP address, an EACL (Extended ACL) wherein the traffic is blocked according to the source IP address, the target IP address and a used polt, a PBR (Policy Base Routing) wherein the packet is blocked according to a size, and combinations thereof. In order to setup the experiment environment, a network traffic of 7680 Kbps and 120 Kpps is generated, and an attack condition is varied four times to carry out the test. As a first test condition, a CPU usage rate is measured when the attack traffic does not occur. As a second test condition, the CPU usage rate is measured when the attack traffic of 1280 Kbps and 20000 pps is generated. As a third test condition, the CPU usage rate is measured when the attack traffic of 2560 bps and 40000 pps is generated. As a fourth test condition, the CPU usage rate is measured when the attack traffic of 5120 Kbps and 80000 pps is generated.

In order to build the test environment similar to an actual environment, 2,400 virtual user environments are built, and a traffic of 7,690 Kbps and 120 Kpps is generated such that a load of the router is maintained at the CPU usage rate of 40% which is similar to the actual environment. In addition, 2,000 virtual DDoS (Distributed Denial of Service) agents are built as an attack environment to transmit the packet to a certain host. That is, a router load generation rate is observed when the EACL, the uRPF, the CAR, the PBR and the blackhole routing which are the security function of the router are applied respectively and simultaneously, and a variation in an increase of the load generation rate is also observed when a bps of the DDoS attack is increased. The equipment to be observed is a 7500 router of Cisco and a packet generator (SmartBit) and a Foundry Layer3 Switch are used.

Graphs showing a variation of the CPU usage rate according to the security function when the amount of the attack traffic is increased four times. To summarize a result of the experiment, the CPU usage rate is lowest when the uRPF and the blackhole routing (null0) technologies of the malicious code blocking technology are used.

The packet having the IP address mc_site ip of the malicious code distribution site 20 as the target IP address or the source address transmitted from the malicious code distribution site detection server 200 may be block using the above-described technologies. However, it is preferable that the blackhole routing and the uRPF technologies which allow a control of the plurality of equipments remotely and have almost no effect on the performance of the equipment are used.

In accordance with the system for preventing the attack of the malicious code spread using the web technology, the null0 routing (blackhole routing) scheme and the remote triggered blackhole routing scheme for blocking an IP based malicious code at the router (L3) level using the uRPF and the IBGP are applied.

As described above, the null0 routing technology is applied to the remote triggered blackhole routing technology. In accordance with the null0 routing which is also referred to as the blackhole routing or blackhole filtering technology, the packet having the certain IP address as the target address or the source address is guided to the null0 which is the virtual IP address and blocked, and a null0 routing rule of the routers in a predetermined group is simultaneously updated using one of the router as a routing server using the IBGP. This allows blocking of the packet having the certain IP address in a plurality of edge router of the ISP (Internet Service Provider) simultaneously. An advertisement of a routing path using the IBGP allows remotely transmitting a routing information to the plurality of edge router sharing the IBGP in AS (Automonous System). In addition, forwarding the certain IP address set in each of the plurality of edge router to the null0 which is a virtual interface provides an effect of dropping the attack traffic by routing the attack traffic to the null0.

FIG. 11 is a diagram illustrating a remote triggered blackhole routing process.

Referring to FIG. 11, a certain IP address such as 192.0.2.1 for a null0 routing 555 in each of the edge routers is designated in advance, and a blackhole routing server 350 advertises such that a traffic heading for a site to be attacked, 111.111.111.111 for example, is redirected to 192.0.2.1, thereby blocking the attack traffic at the entirety of the edge routers 550.

Specifically, in order to setup the remote triggered blackhole routing, a routing path is designated such that each of the edge routers 550 carries out the null0 routing 555 of the certain IP address (192.0.2.1) or an IP block. The certain IP address routed to null0 555 at the edge routers 550 is generally selected from private IP blocks. When the edge routers 550 are prepared, the blackhole routing server 350 informs the edge routers 550 of the routing path such that the traffic containing the IP address to be blocked (111.111.111.111) is redirected to the certain IP address or the IP block. the edge routers 550 that have received the routing path from the blackhole routing server 350 which advertises an IBGP path drops the attack traffic by combining a predetermined null0 routing rule.

An example of a target-based remote triggered blackhole routing technology and a source-based remote triggered blackhole routing technology of the remote triggered blackhole routing will now be described.

In accordance with the target-based remote triggered blackhole routing, an entire traffic heading for a certain target may be blocked by the edge routers 550. in accordance with the technology, an address of the router through which the packet should pass in order to reach the target, that is a next hop address of an attack object system through an IBGP network is changed to the IP address designated to lead to the blackhole (null0).

In order to achieve this, a preparation for the IBGP advertisement in the blackhole routing server 350 of the ISP and the null0 routing is set in each of the edge routers 550. When the attack occurs, a DNS (Domain Name Server) information is changed in the site to be attacked, and a command is transmitted to each of the edge routers 550 to drop the packet headed for an IP address to be attacked. In order to carry out the above-described function, a process in the edge routers 550 and the blackhole routing server 350 are as follows.

An IP address that is not used for configuring the blackhole is selected in the edge routers. That is, an IP address or an IP block dedicated to the blackhole filtering is selected. Generally, the IP address or the IP block is selected from the private IP addresses defined by RFC 1918, may not be used for other purposes in the same AS.

In addition, the edge routers 550 sets a special static path to route the selected IP address or the IP block to the null0 interface for the blackhole filtering. That is, when the ‘next-hop’, which is a router address to be passed through by the attack traffic in case of the attack, is designated as the selected IP address, the attack traffic is routed to the null0 interface to be blocked.

The null0 interface in the edge routers may be defined as shown in Table 1.

TABLE 1

interface Null0
no icmp unreachable

When the attack traffic is block by the null0 interface, a “packet is not transmitted” message is transmitted a source address, wherein “no icmp unreachable” command of the table 1 may be used to prevent an overload due to the message. However, in accordance with the source-based remote triggered blackhole routing technology described later, the message may be required to be generated in order to trace the attacker.

Moreover, when the selected address is 192.0.2.1, each of the edge routers 550 sets the static path as shown in table 2.

TABLE 2

ip route 192.0.2.1 255.255.255.255 Null0

The Table 2 shows a configuration command in case of a Cisco router. When the router is a Juniper router, the configuration command is shown in table 3.

TABLE 3

set routing-options static route 192.0.2.1/32 reject install

When the next-hop is set such that the attack packet is redirected to 192.0.2.1 in the blackhole routing server (or the blackhole router) through the router configuration, the attack packet is automatically dropped from 192.0.2.1 to the null0 region.

The configuration method of the edge routers of the target-based remote triggered blackhole routing technology is described above. A preparation of the blackhole router will now be described.

A designation and a configuration of a blackhole router server are as follows.

One of the routers on the network is designated as the blackhole router server. The router informs the edge routers of a new routing information every time the attack to the certain site occurs. While the router, which is only for the IBGP, is not required to have a high performance, it is preferable that the router is a dedicated the blackhole router server. In addition, the router may be managed by an NOC (Network Operation Center) or an SOC (Secure Operation Center) wherein the network is monitored by the ISP for 24 hours such that the router may correspond to the attack.

In order to carry out the function as the blackhole router server, the blackhole router server should be configured to redistribute the static path in order to immediately transmit a static path process to be configured in case of the attack to the edge routers 550 through the IBGP. Table 4 show a configuration for carrying out the above-described function in the Cisco router, and Table 5 show a configuration for carrying out the above-described function in the Juniper router.

TABLE 4

! jump into the bgp router config
! router bgp 31337
! redistribute static route-map static-to-bgp
! route-map static-to-bgp permit 5
match tag 666
set ip next-hop 192.0.2.1
set local-preference 50
set community additive no-export
set origin igp

TABLE 5
set protocol bgp group XXX export BlackHoleRoutes
#
set policy-statement BlackHoleRoutes term match-tag666
from protocol static tag666
set policy-statement BlackHoleRoutes term match-tag666
then local-preference 50
set policy-statement BlackHoleRoutes term match-tag666 then
origin igp
set policy-statement BlackHoleRoutes term match-tag666
then community add no-export
set policy-statement BlackHoleRoutes term match-tag666
then nexthop 192.0.2.1
set policy-statement BlackHoleRoutes term match-tag666 then accept

A description of attributes used in a configuration of the Tables 4 and 5 is as follows.

The next-hop is the router address that the packet should pass in order to reach the target, and a local-reference denotes a preference with respect to an external path, a community denotes grouping of routers according to their characteristics, a no-expect denotes not transmitting a BGP (Border Gateway Protocol) message including this value. In accordance with the configuration shown in FIG. 4, when the static path having a tag 666 is generated, the static path is routed to 192.0.2.1, and the advertisement is not advertise to the external AS and used only internally. The routers to be used may be grouped using the community. For instance, when a network having a BGP AS number 65001 includes two edge routers R1 and R2, community values 65001:1 and 65001:2 are allocated to the R1 and the R2 respectively, and a community value 65001:666 is allocated such that both the R1 and R2 recognizes the community value 65001:666, thereby allowing give a command to the R1 and R2 separately or to both of the R1 and R2. The community provides a means that may be applied to cope with the attack with a more flexibility. The command may be given to an entire subscriber router group or to an international network router when the attack is from overseas using the community. In addition, routers of a network of a dedicated subscriber line or high speed subscriber line may be divided for a management.

Changing the routing information of a large network should be approached very carefully. An incorrect routing information may affect the routing path of other ISPs as well as the corresponding ISP. In accordance with the remote triggered blackhole routing technology, a measure for reducing such risk is shown in table 6.

TABLE 6

| Technology | description |
|---|---|
| no-export BGP | applied only to the corresponding ISP (AS) and the |
| Commnunity | information is not updated for other ISPs |
| additional | limiting the router group being applied within the |
| community | corresponding ISP similar to 65001:666, which is an |
| filtering | additional measure after no-export |
| curb of prefix | for instance, prefix of no more than /24 is not |
| having small size | transmitted to adjacent ISPs (a predetermined |
| | address from /25 through /32 are used for the |
| | blackhole) |

The preparations in each of the edge routers and the blackhole router server are completed through the above described steps. A process for responding to the attack aimed at a customer's site will now be described.

Firstly, the attacked site discards the IP address that is the target of the attack, and the DNS information of the customer's site is modified. Most of the DDoS attack does not designate the domain name but uses the IP address of the corresponding site in order to reduce a delay in an attack time according to a DNS query when designating an object to be attacked. When a DNS entry of the system to be attacked is changed in a name server of the site to be attacked, a reflection of the changed information to a general user has time differences according to a TTL (Time To Live) value set in the DNS server of the site being attacked. The TTL value of a DNS resource record is a time in seconds during which a certain server caches the record. For instance, the TTL value of an aaa.test.co.kr record is 3600 seconds, the record is cached outside the company, and the aaa.test.co.kr record is deleted from a cache after 1 hour. An information regarding aaa.test.co.kr is re-fetched when a corresponding data is required. When TTL value is small, a copy of the data stored in a cache server includes an updated information while affecting a load of the name server. It is preferable that the TTL value is set to be small in advance when the system is altered often, the site is frequently visited or the site may be the target of the attack. The TTL information set in the site may be verified using an nslookup command. On the other hand, a service carried out in the corresponding IP address may be continued buy changing the DNS information at the customer's site. However, since the attack traffic is still incoming into the IP address to be attacked, an overload may occur in a border router of the customer that includes the IP address being attacked and a bandwidth thereof may be exhausted. Therefore, the ISP should activate the remote triggered blackhole routing prepared in advance to block the attack traffic at the edge routers. In order to activate the remote triggered blackhole routing, the static path containing a predetermined tag, 666 in this example, is added in the blackhole router server. A setting is shown in FIG. 7 when the Cisco router is used as the blackhole router server, and a setting is shown in FIG. 8 when the Juniper router is used as the blackhole router server.

TABLE 7

ip route victimip 255.255.255.255 null0 tag 666

TABLE 8

set routing-options static route victimip/32 discard tag 666

The static path having the tag 666 directs the entire edge routers included in the corresponding community group by the configuration of the table 4 to drop an entire traffic heading for the IP address to be attacked. One consideration to be taken into is that the traffic should be blocked by the blackhole only for a target host or target hosts, not an entire address block to which the target host or the target hosts belongs so as to minimize an effect on the network under attack. That is, other traffics in the network should normally reach the target IP address except the host or the hosts to be blocked by the blackhole such that other services of the organization under attack are not affected.

A configuration example for applying the target-based remote triggered blackhole routing technology at each of the edge routers and the blackhole router server is described above. An example for configuring the router server using the source-based remote triggered blackhole routing technology will now be described.

The source-based remote triggered blackhole routing technology is a variation of the target-based remote triggered blackhole routing technology, wherein an uRPF function should be additionally configured for interfaces of each of the edge routers. In accordance with the source-based remote triggered blackhole routing technology, the uRPF technology is used as a key technology in conjunction with the null0 routing technology and an IBGP advertising function. As described above, the uRPF is a technology used for verifying the source of the packet, which may be applied to effectively block the spoofed packet. Generally, the uRPF has a strict mode and a loose mode as shown in table 9.

TABLE 9

| | strict | loose |
|---|---|---|
| types | uRPF | uRPF |
| when FIB (Fowarding Information Base) does not exist | drop | drop |
| when routed to the null0 | drop | drop |
| when an interface into which the packet is inputted differs | drop | pass |
| from that of the reverse path | | |
| when the interface into which the packet is inputted is | pass | pass |
| identical to that of the reverse path | | |

As described above, in accordance with the source-based remote triggered blackhole routing technology, the three main technologies are combined as shown in table 10 in order to block the attack occurring at the certain address.

TABLE 10

| main technology | function |
|---|---|
| Null0 routing | drops the packet when the target address is null0 |
| IBGP | advertises to the edge routers in the AS that the |
| advertisement | address of the attacker is routed to the null0 |
| uRPF | drops the packet when the reverse path of the source |
| | is heading for the null0 |

That is, when a manager of the NOC advertises a list of the source address to be blocked through the IBGP advertisement, the edge routers of the ISP inquires the reverse path of the malicious code distribution site by the uRPF and the null0 configurations to drop the packet having the corresponding source address.

Configurations of the edge router and the blackhole routing server for the source-based remote triggered blackhole routing will now be described.

The source-based remote triggered blackhole routing is based on the edge routers configured in the target-based remote triggered blackhole routing and a configuration of the blackhole routing server. Configuring the uRPF for the edge routers is also added. The configuration of the uRPF should be carried out for each of the interfaces, and it is preferable that the uRPF is configured at an entry point of the attack. For instance, the uRPF may be configured at IX (Internet exchange) connected to other ISPs or at an interface of the subscriber. When the attack is detected by the malicious code distribution site detection server 200 and the IP address to be blocked is obtained, the router is configured as shown in table 11 for the Cisco router and table 12 for the Juniper router.

TABLE 11

ip route attacker_ip 255.255.255.255 null0 tag 666

TABLE 12

set routing-options static route attacker_ip/32 discard tag 666

Referring to tables 11 and 12, the static path containing the tag 666 activates the remote triggered blackhole routing.

Even when the number of the source addresses to be blocked is tens or hundreds, the ISP is only required to add the corresponding address to a FIB table so as to be routed to the predetermined address, which is eventually routed to the null0.

An example of configuring the router for the target-based remote triggered blackhole routing of the remote triggered blackhole routing has been described above.

FIG. 12 is a diagram illustrating routers wherein the remote triggered blackhole routing technology is applied thereto in accordance with an embodiment of the present invention.

Referring to FIG. 12, the blackhole routing server 350 advertises the routing path to the edge routers 550 using the IBGP such that the IP address of the malicious code distribution site 20 transmitted from the malicious code distribution site detection server 200 is blocked. In addition, the edge routers 550 received the a configuration information of the routing path from the blackhole routing server 350 to guide the connection of the user to the virtual IP address null0 designated in the edge routers 550 in advance, thereby blocking the connection of the user to the malicious code distribution site 20 as well as guiding and dropping the malicious code coming in from the malicious code distribution site 20.

In order to achieve this, the blackhole routing server (a typical router), which is capable of advertising an IP address information to be blocked received from the malicious code distribution site detection server 200, is designated and a measure is taken to secure the null0 region by the edge routers 550.

In accordance with the embodiment of the present invention, a separate edge router for collecting and analyzing the malicious code may be used by forwarding the malicious code coming in from the malicious code distribution site to the virtual IP address.

A method for preventing a malicious code spread using a web technology in accordance with an embodiment of the present invention will be described below.

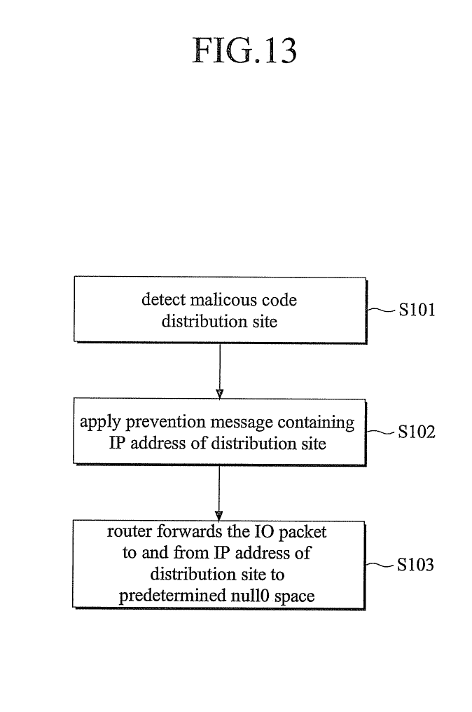

FIG. 13 is a flow diagram illustrating a method for preventing a malicious code spread using a web technology in accordance with an embodiment of the present invention.

Referring to FIG. 13, the malicious code distribution site is detected for the first time (S101).

In the step S101, a website is scanned according to an order of an importance by referring to a domain database having a domain to be scanned or the website is scanned arbitrarily to investigate whether the malicious code is inserted in the website, thereby selecting the malicious code distribution site.

Thereafter, a prevention message including an IP address of the detected malicious code distribution site is applied to a plurality of routers 500.

In the step S102, the prevention message including the IP address of the malicious code distribution site and a router control code is generated and applied to the routers 500. The prevention message may be transmitted to the routing configuration server 300 to register the IP address of the malicious code distribution site 20 in the routers 500 using the IBGP or the malicious code distribution site detection server 200 may directly communicate with the IGBP to configure the routers 500.

Finally, the routers forward an IO packet from and to the malicious code distribution site to the predetermined null0 space (S103).

In the step S103, each of the routers 500 designates the virtual IP address or block for forwarding the packet heading for the certain target or transmitted from the certain source, and guides the packet heading for or coming from the IP address of the malicious code distribution site to the virtual null0 space to be dropped.

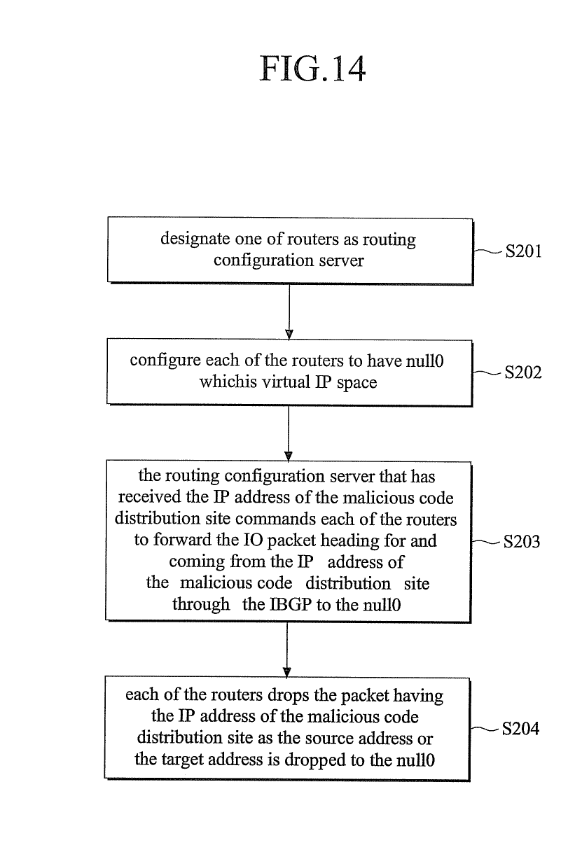

FIG. 14 is a flow diagram illustrating a process for applying a remote triggered blackhole routing technology to router in accordance with an embodiment of the present invention.

Referring to FIG. 14, one of the plurality of routers is designated as the routing configuration server (S201).

In the step S201, one of the routers is designated as the IBGP server that advertises the routing path to each of the routers such that the packet containing the IP address of the malicious code distribution site is redirected to the designated IP address (null0) or the IP block.

Thereafter, each of the routers is configured to have the null0 which is the virtual IP space (S202).

In the step S202, the routing path is configured for each of the edge routers 550 except the routing configuration server (or the blackhole routing server 350) to route the certain IP address or the IP block to the null0.

Thereafter, the routing configuration server receives the IP address of the malicious code distribution site and commands each of the routers to forward the IO packet heading for and coming from the IP address of the malicious code distribution site through the IBGP to the null0.

Finally, each of the routers drops the packet having the IP address of the malicious code distribution site as the source address or the target address is dropped to the null0.

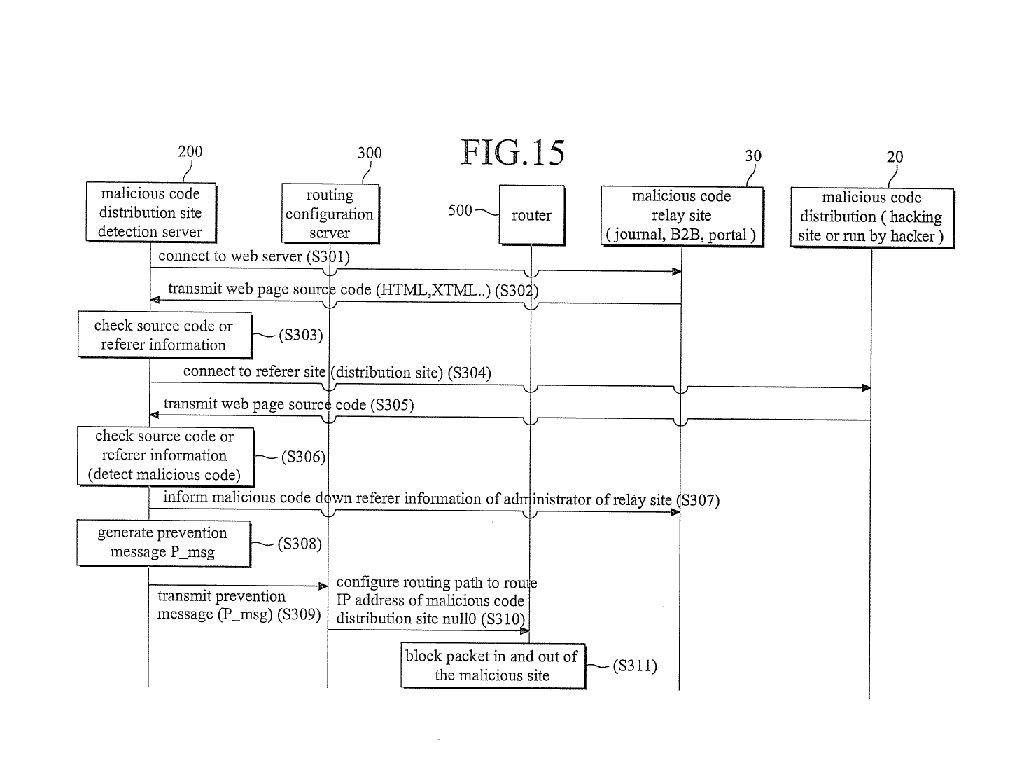

FIG. 15 is a flow diagram illustrating an operating relation between elements of a system for preventing a malicious code spread using a web technology in accordance with an embodiment of the present invention.

Referring to FIG. 15, the malicious code distribution site detection server 200 connects to the website or arbitrarily connects to the website by referring to the domain database 260 containing a list of the site to be monitored including an order of priority.

Thereafter, the webpage source code (the HTML, the XML, a java script) is collected (S302), and the malicious code distribution site detection server 200 compares the source code with the malicious code pattern information stored in the malicious code pattern database 220 to check whether the malicious code is hidden or the referrer information. When the malicious code is detected, the website is regarded as the malicious code distribution site 20 and the packet in and out of the malicious code distribution site 20 is block while connecting to a referrer site, i.e. the malicious code distribution site 20 by investigating a linked site (S304).

The webpage source code (the HTML, the XML and the javascript) is collected (S305) and the source code and a referrer property are checked (S306) to determine the malicious code distribution site. When determined to be the malicious code distribution site 20, the administrator of the relay site 30 linking the malicious code distribution site 20 is informed of a malicious code download referrer information so that a necessary measure may be taken (S307).

In addition, the prevention message P_msg including the IP address of the malicious code distribution site 20 and the router control code is generated and transmitted to the routing configuration server 300 simultaneously with the step S307 (S309).

The message server 330 that has received the prevention message P_msg serves as the blackhole routing server to advertise to the routers 500 in the AS using the IBGP to drop the packet having the IP address of the malicious code distribution site as the target address or the source address (S310). In addition, the routers 500 sets the path of every packet containing the IP address of the malicious code distribution site to the null0 to be dropped.

On the hand, while the embodiment of the present invention exemplifies the Cisco router and the Juniper router when applying the remote triggered blackhole routing scheme to the router, a scope of the present invention is not limited thereto but applicable to various routers, and the configuration method for applying the blackhole routing scheme to the router may be subjected to various changes in form and details without departing from the spirit and scope of the present invention.

As described above, in accordance with the system and the method for preventing an attack of a malicious code spread using a web technology of the present invention, a malicious code distribution site or a relay site is automatically detected using a HTML web page source and a referrer information of a plurality of websites and a user connection to the malicious code distribution site or a spreading of the malicious code using a remote triggered blackhole routing.

In addition, in accordance with the system and the method for preventing an attack of a malicious code spread using a web technology of the present invention, a change in a routing configuration is exchanged a remote triggered blackhole routing technology without replacing an security equipment and changing the system is exchanged, that is a routing information between a blackhole router and a edge router is exchanged using a interior/border gateway protocol remotely to minimize a degradation of an equipment performance and without a large amount of a replacement cost.

Finally, in accordance with the system and the method for preventing an attack of a malicious code spread using a web technology of the present invention, the malicious code distribution site is automatically detected and the routing information is automatically applied to the router in order to collect and block the malicious code hidden in the plurality of websites to be distributed and relayed, thereby promptly blocking a use connection to the malicious code distribution site and informing the malicious code distribution site to collect and analyze the malicious code.

While the present invention has been particularly shown and described with reference to the preferred embodiment thereof, it will be understood by those skilled in the art that various changes in form and details may be effected therein without departing from the spirit and scope of the invention as defined by the appended claims

What is claimed is:

1. A system for preventing a malicious code spread using a web technology, the system comprising:
a malicious code distribution site detection server comprising a malicious code distribution site detector for detecting a malicious code distribution site, and a prevention message transmitter for transmitting a prevention message to a routing configuration server, wherein the prevention message includes an IP address of the malicious code distribution site detected by the malicious code distribution site detector;
a plurality of routers including a virtual IP address; and
the routing configuration server for advertising the IP address of the malicious code distribution site such that a routing path of a packet having the IP address of the malicious code distribution site as a target address or an starting address is guided to the virtual IP address according to an reception of the prevention message to block a connection to the malicious code distribution site.

2. The system in accordance with claim 1, wherein the malicious code distribution site detector comprises a domain database having a domain of a website to be monitored registered therein, and wherein the malicious code distribution site detector monitors the website periodically or non-periodically to check whether a link information to the malicious code distribution site is included in the domain database so as to detect a malicious code relay site.

3. The system in accordance with claim 1, wherein the malicious code distribution site detection server comprises a malicious code pattern database having a malicious code pattern stored therein, and wherein the malicious code distribution site detection server searches a website on a network to collect a source code of the website, and checks whether the malicious code is hidden in the website by comparing the collected source code and the malicious code pattern stored in the malicious code pattern database to detect the malicious code distribution site.

4. The system in accordance with claim 3, wherein the source code includes at least one of a HTML source code, a XML source code and a script source code.

5. The system in accordance with claim 1, wherein method for blocking a connection to the malicious code distribution site includes at least one of an ACL, a null0 routing, an uRPF, a Rate-limit, a netflow and a remote triggered blackhole routing.

6. The system in accordance with claim 1, wherein in the advertising employs an interior/external gateway protocol.

7. The system in accordance with claim 1, wherein the virtual IP address includes a null0 routed private IP address.

8. The system in accordance with claim 1, wherein the routing configuration server is one of the plurality of routers.

9. The system in accordance with claim 1, wherein the malicious code distribution site detection server comprises a post-monitoring unit for reporting a hacking to the malicious code distribution site and the malicious code relay site, the post-monitoring unit checks after a predetermined period whether the malicious code is hidden to re-report the hacking or to stop the block of the connection to the malicious code distribution site.

10. A method for preventing a malicious code spread using a web technology, the method comprising:
(a) detecting a malicious code distribution site;
(b) applying a prevention message including an IP address of the detected malicious code distribution site to a plurality of routers; and
(c) forwarding, by the plurality of routers, an IO packet from and to the malicious code distribution site to a predetermined virtual IP space.

11. The method in accordance with claim 10, wherein the step (a) comprises:
(a-1) connecting to a website to be monitored by receiving a domain list of the website from a domain database or arbitrarily connecting to the website;
(a-2) collecting a source code including at least one of HTML source code, a XML source code and a script source code of the website and comparing the collected source code and a malicious code pattern stored in a malicious code pattern database to check whether the malicious code is hidden; and
(a-3) analyzing a referrer information of the website to check whether a link to the malicious code distribution site is included in the referrer information to simultaneously connect to a referrer site and detect the malicious code distribution site by a method identical to the step (a-2).

12. The method in accordance with claim 10, the step (b) comprises:
(b-1) generating the prevention message including the IP address of the malicious code distribution site and a router control code; and
(b-2) transmitting the prevention message to a separate routing configuration server to configure a routing path of an IP address to be blocked for each of the plurality of routers, or directly transmitting the prevention message to the plurality of routers to configure the routing path of the IP address to be blocked.

13. The method in accordance with claim 10, the step (c) comprises:
(c-1) designating one of the plurality of routers as a routing configuration server;
(c-2) assigning a null0 of the virtual IP space to the plurality of routers;
(c-3) advertising to the plurality of routers using an interior/external gateway protocol such that the plurality of routers directs the IO packet from and to the malicious code distribution site to the null0; and
(c-4) dropping, by the plurality of routers, the IO packet having the IP address of the malicious code distribution site as a starting address or a target address to the null0.

14. The method in accordance with claim 10, wherein the virtual IP space includes a null0 routed private IP address.

15. The system in accordance with claim 2, wherein the malicious code distribution site detection server comprises a post-monitoring unit for reporting a hacking to the malicious code distribution site and the malicious code relay site, the post-monitoring unit checks after a predetermined period whether the malicious code is hidden to re-report the hacking or to stop the block of the connection to the malicious code distribution site.

16. The method in accordance with claim 13, wherein the virtual IP space includes a null0 routed private IP address.
